(19) United States
(12) Patent Application Publication
(10) Pub. No.: US 2018/0353368 A1
(43) Pub. Date: Dec. 13, 2018

(54) Scalp reliever

(71) Applicant: Zuheerah Muhammad, Azusa, CA (US)

(72) Inventor: Zuheerah Muhammad, Azusa, CA (US)

(21) Appl. No.: 15/705,636

(22) Filed: Sep. 15, 2017

Related U.S. Application Data
(60) Provisional application No. 62/518,654, filed on Jun. 13, 2017.

(51) Int. Cl. A61H 7/00; A45D 24/02

(52) U.S. Cl. CPC A61H 7/003; A45D 2024/005; A45D 24/02

(57) ABSTRACT

This invention is used for scratching the scalp with any hairstyle. It is a scalp reliever. It has two, three or four teeth that are flexible enough to get into areas of the scalp that cannot be reached while wearing pony tails with gelled hair that is laid down and/or glued/stuck in place, buns, pinned-up hair, cold waves, curls, salon styles, performance hairdos, braids, dregoodrawes, latch hooks, bantoo knots, afros, lace front wigs, secured hair styles, etc. This invention allows consumers to bend the teeth of the comb and get into hard to reach places beneath their hair whether their natural hair or hair that is attached to their scalp being sewn in or glued or even partial wigs. The device allows consumers to get relief from an itchy scalp. It also gets into places that are hard to reach. The device can be guided underneath stationary hair, since the teeth are bendable and flexible. One can also comb their hair with the device. It can also be used to take down braids or untangle hair. The invention is made out of fiberglass and plastic and is attached to a base that allows it to fit in your hand, cosmetic bag, purse, pocket, etc.

### BACKGROUND

This device is used for scratching the scalp with any hairstyle. It is a scalp reliever. It has two, three or four teeth that are flexible enough to get into areas of the scalp that cannot be reached while wearing pony tails with gelled hair that is laid down and/or glued/stuck in place, buns, pinned-up hair, cold waves, curls, salon styles, performance hairdos, braids, dreadlocks, weaves, latch hooks, bantoo knots, afros, lace front wigs, secured hair styles, etc. This invention allows consumers to bend the teeth of the comb and get into hard to reach places beneath their hair whether their natural hair or hair that is attached to their scalp being sewn in or glued or even partial wigs. The device allows consumers to get relief from an itchy scalp. It also gets into places that are hard to reach. The device can be guided underneath stationary hair, since the teeth are bendable and flexible. One can also comb their hair with the device. This device can also be used to take braids, locks, and other hairdos down. The invention is made out of fiberglass and plastic and is attached to a base that allows it to fit in your hand, cosmetic bag, purse, pocket, etc.

### BRIEF DESCRIPTION OF DRAWINGS

FIG. 1: Beetlebug viewed from the right angle. The measurements of the are as follow; Height 5/16″, Width 1¼″, Length 1 5/16″.

All measurements are done at the longest points of BB.

FIG. 2: Second view of Bettlebug

FIG. 3 Diagonal viewing of Beetlebug.

FIG. 4 The top part of the Beetlebug has three holes that receive the prongs or teeth that protrude from the base of the Beetlebug.

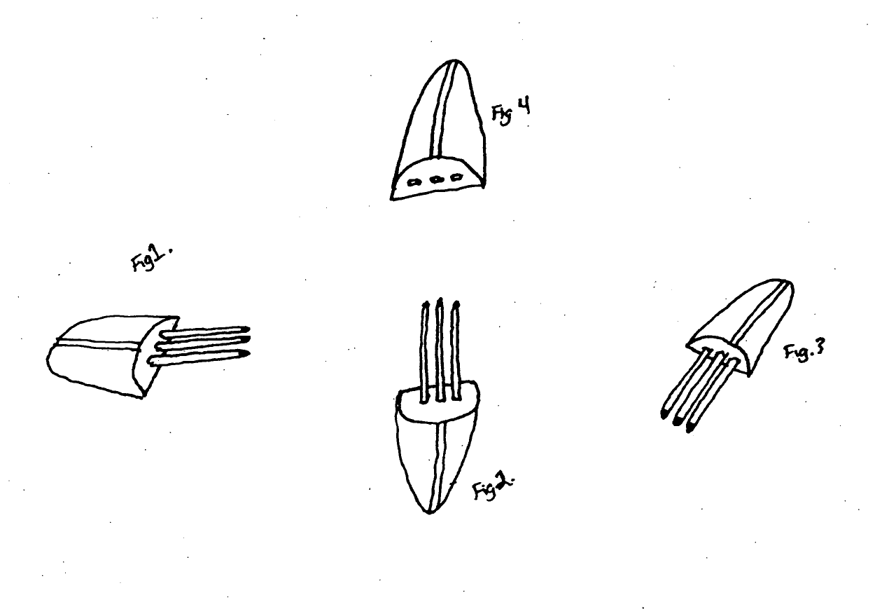

The invention claimed is:

1. The instrument is designed to be an all-around tool for scratching the scalp, relieving itching easily.

2. The device according to claim 1 is for combing and untangling hair while wet or dry.

3. The device according to claim 1 is an instrument with a top piece that sits in your hand and is attached to two, three or four flexible prongs which bend, allowing you to place it where you want in order to give yourself relieve from your scalp by moving it in a back and forth, side to side or circular motion.

4. The device according to claim 1 has attached bobby pins, which make it bendable and flexible to move in many directions.

5. The device according to claim 1 is comprised of a light fiberglass material with a gel coating on top and has a small handle that fits in the palm of your hand.

6. The device according to claim 1 has two, three or four prongs that are attached and bendable and able to be controlled in one's hand and directed to reach the scalp to scratch it.

7. The device according to claim 1 can comb through tangled and/or matted hair, untangling it.

8. The device according to claim 1 can assist in taking braids down by holding the device in your hand and raking from the bottom up of the braid or twisted hair, forcing it to untwist or unbraid.

9. The device according to claim 1 can get into or under hard to reach places on the scalp that are covered by hair that is in a stationary position, scratching it without having the hair become messy or unkempt.

10. The device according to claim 1 can be used on any hairstyle there is to relieve the scalp of itching.

11. The device according to claim 1 can be used at any time and in any place without causing attention to one scratching their head. This device will alleviate the embarrassment of scratching or patting on the head in public.

12. The instrument according to claim 1 is designed to reach the scalp from many angle, using the flexible prongs or bobby pin teeth of the device, directing them to scratch the scalp over braids, pony tails, slicked down hair, twists, buns, dreads, partial wigs, weaves or any type of hairstyle.
